(19) United States
(12) Patent Application Publication
(10) Pub. No.: US 2014/0372810 A1
(43) Pub. Date: Dec. 18, 2014

(54) APPARATUS AND METHOD FOR MONITORING PERFORMANCE OF CORES BASED ON MULTI-CORE PROCESSOR

(71) Applicant: ELECTRONICS AND TELECOMMUNICATIONS RESEARCH INSTITUTE, Daejeon City (KR)

(72) Inventor: Gap-Joo NA, Daejeon (KR)

(21) Appl. No.: 14/301,364

(22) Filed: Jun. 11, 2014

(30) Foreign Application Priority Data
Jun. 14, 2013 (KR) 10-2013-0068437

(51) Int. Cl. G06F 11/30; G06F 11/34

(52) U.S. Cl. CPC G06F 11/3017; G06F 11/3433
USPC 714/47.1

(57) ABSTRACT

An apparatus and method for monitoring the performance of cores based on a multi-core processor. The apparatus includes a status information collection unit and a monitoring unit. The status information collection unit collects a plurality of pieces of status information extracted from respective cores, and stores the plurality of pieces of status information in respective memory areas provided for the cores. The monitoring unit receives the status information, sends the status information to a storage unit, and performs monitoring based on the status information. The monitoring unit is provided in any one of the cores.

### CROSS REFERENCE TO RELATED APPLICATION

This application claims the benefit of Korean Patent Application No. 10-2013-0068437, filed on Jun. 14, 2013, which is hereby incorporated by reference in its entirety into this application.

### BACKGROUND OF THE INVENTION

1. Technical Field

The present invention relates generally to an apparatus and method for monitoring the performance of cores based on a multi-core processor and, more particularly, to an apparatus and method for monitoring the performance of cores based on a multi-core processor, which are capable of monitoring the performance of the cores attributable to an operating system based on a multi-core processor.

2. Description of the Related Art

Processor development methodology has changed from a conventional approach oriented toward fast clock speed to improve the performance of computing to a technical development approach oriented toward an increase in the number of cores, thereby lowering power consumption while improving performance.

Such a new processor is referred to as a “multi-core processor,” and is also referred to as a “manycore processor” based on the number of cores. Multi-core processors have been widely used in a variety of fields because of the advantage of improving performance by simultaneously performing tasks assigned to respective cores and the advantage of lowering power required for each core. In particular, multi-core processors have been rapidly applied to embedded apparatuses that have severe limitations in power.

Meanwhile, various techniques, such as a parallel computing technique, have appeared to utilize a multi-core processor. However, unless the scheduling technique of an operating system, such as the fair assignment of tasks to cores, is provided, the degree of use of existing cores is low, and thus it is difficult to expect an improvement in performance.

To solve the above problems, various techniques for managing tasks or processes (a scheduler, or a scheduling technique) have been applied to an operating system that runs on a multi-core processor. Unlike an existing operating system that manages tasks based on a single core, a multi-core based task scheduler has the advantage of assigning tasks to cores and balancing the load between cores, thereby increasing the rate of use of the overall processor. In this regard, Korean Patent Application Publication No. 10-2007-0090649 discloses an apparatus and method for providing cooperative scheduling in a multi-core system.

However, since techniques or tools for evaluating the performance of a multi-core based task scheduler are designed based on a single core-based processor, a problem arises in that it is difficult to evaluate the characteristics of a multi-core processor. That is, the distortion of performance characteristics may occur depending on the time at which a task of measuring performance is performed and the core on which a task of measuring performance is performed. Furthermore, monitoring software for evaluating performance has the problem of increasing overhead for the measurement of performance because of a cache problem between cores and an input/output problem regarding a storage device.

### SUMMARY OF THE INVENTION

Accordingly, the present invention has been made keeping in mind the above problems occurring in the conventional art, and an object of the present invention is to provide an apparatus and method for monitoring the performance of cores based on a multi-core processor, which are capable of collecting a plurality of pieces of status information for respective cores and then monitoring the performance of the cores, in order to evaluate the performance of the cores attributable to an operating system based on a multi-core processor.

Another object of the present invention is to provide an apparatus and method for monitoring the performance of cores based on a multi-core processor, which include a monitoring means in any one of a plurality of cores, thereby fairly monitoring the performance of all the cores.

In accordance with an aspect of the present invention, there is provided an apparatus for monitoring the performance of cores based on a multi-core processor, including a status information collection unit configured to collect a plurality of pieces of status information extracted from respective cores, and to store the plurality of pieces of status information in respective memory areas provided for the cores; and a monitoring unit configured to receive the status information, to send the status information to a storage unit, and to perform monitoring based on the status information, wherein the monitoring unit is provided in any one of the cores.

The cores may include respective status information extraction units each configured to extract the plurality of pieces of status information.

Each of the plurality of pieces of status information may be information including at least one of a number of tasks or an amount of data that have been processed for each of the cores.

The status information collection unit may include a memory unit configured to have a plurality of different memory areas for the respective cores, and to store the plurality of pieces of collected status information in the respective memory areas; a scheduling determination unit configured to determine whether each of tasks, which have been assigned to the respective cores corresponding to the plurality of pieces of status information that are stored in the respective memory areas, is a scheduling target; a core setting unit configured to fixedly set locations of the tasks so that the tasks are performed only in the respective assigned cores; and a core determination unit configured to determine whether the task, which is a scheduling target, has been assigned to the core provided with the monitoring unit.

If the task, which is a scheduling target, is a task assigned to the core provided with the monitoring unit, the monitoring unit sends the stored status information to the storage unit, resets the status information collection unit, and then performs the monitoring.

In accordance with another aspect of the present invention, there is provided a method of monitoring the performance of cores based on a multi-core processor, including collecting, by a status information collection unit, a plurality of pieces of status information extracted from respective cores, and storing, by the status information collection unit, the plurality of pieces of status information in respective memory areas provided for the respective cores; and storing, by a monitoring unit provided in any one of the respective cores, the plurality of pieces of collected status information in a storage unit, and performing, by the monitoring unit, monitoring based on the status information.

The method may further include, before collecting the plurality of pieces of status information extracted from the respective cores and storing the plurality of pieces of information in the respective memory areas, providing the cores with respective status information extraction units each configured to extract the plurality of pieces of status information.

Collecting the plurality of pieces of status information extracted from the respective cores and storing the plurality of pieces of information in the respective memory areas may include storing the plurality of pieces of collected status information in respective different memory areas provided for the respective cores; determining whether each of tasks, which are assigned to the respective cores corresponding to the plurality of pieces of status information stored in the memory areas is, a scheduling target; fixedly setting positions of the tasks so that the tasks are performed only in the respective assigned cores; and determining whether the task, which is a scheduling target, has been assigned to the core provided with the monitoring unit.

Storing the plurality of pieces of collected status information in the storage unit and performing monitoring based on the status information may include determining whether the core to which the task, which is a scheduling target, has been assigned is the core provided with the monitoring unit; and storing the plurality of pieces of collected status information in the storage unit, resetting the status information collection unit, and then performing the monitoring.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a multi-core processor-based task scheduler according to an embodiment of the present invention;

FIG. 2 is a diagram illustrating the configuration of an apparatus for monitoring the performance of cores based on a multi-core processor according to an embodiment of the present invention;

FIG. 3 is a diagram illustrating the detailed configuration of an apparatus for monitoring the performance of cores based on a multi-core processor according to an embodiment of the present invention;

FIG. 4 is a diagram illustrating the detailed configuration of a status information collection unit adopted in an apparatus for monitoring the performance of cores based on a multi-core processor according to an embodiment of the present invention;

FIG. 5 is a diagram illustrating the detailed configuration of a memory unit provided in the status information collection unit of FIG. 4; and

FIG. 6 is a diagram illustrating the sequence of a method of monitoring the performance of cores based on a multi-core processor according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present pertains can easily practice the present invention. It should be noted that same reference numerals are used to designate the same or similar elements throughout the drawings. In the following description of the present invention, detailed descriptions of known functions and constructions which are deemed to make the gist of the present invention obscure will be omitted.

An apparatus and method for monitoring the performance of cores based on a multi-core processor according to embodiments of the present invention are described in detail with reference to the accompanying drawings.

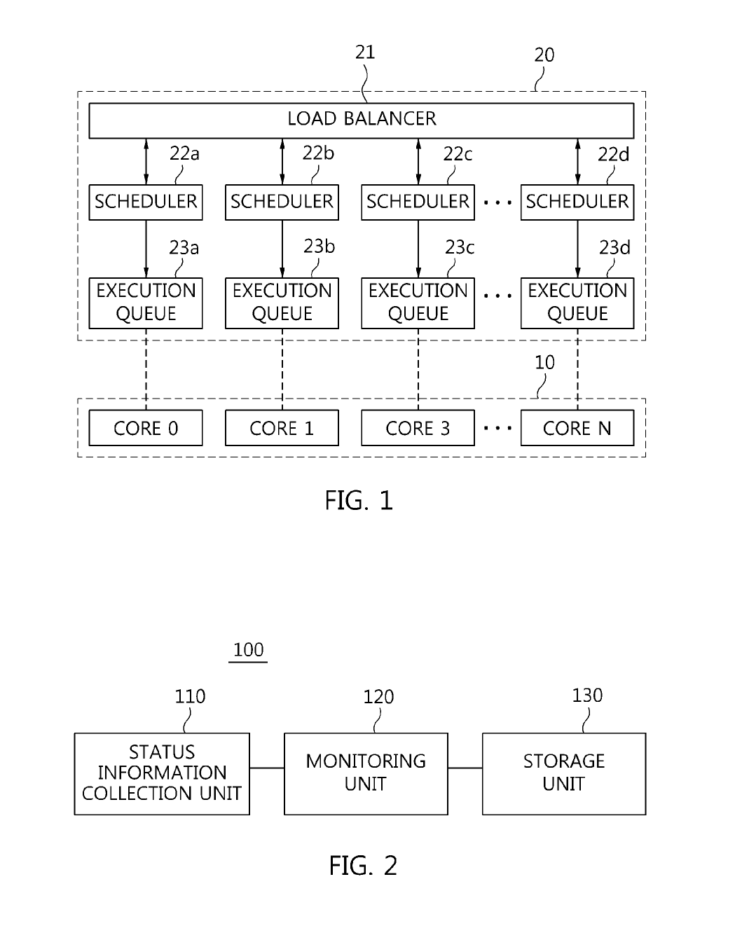

FIG. 1 is a diagram illustrating the configuration of a multi-core processor-based task scheduler according to an embodiment of the present invention.

Referring to FIG. 1, a multi-core processor system according to the present invention includes a multi-core processor 10 including a plurality of cores, and a task scheduler 20. The task scheduler 20 includes a load balancer 21, schedulers 22a, 22b, 22c and 22d, and execution queues 23a, 23b, 23c and 23d.

First, it is assumed that at least one application is being executed on the multi-core processor system. The application assigns the tasks of newly generating data or converting existing data into other type of data to a plurality of cores. The load balancer 21 determines the control of the sequence of the execution of the tasks assigned to the respective cores. The load balancer 21 determines the assignment of requested tasks to the cores. Although the performance of a general task scheduler varies depending on the characteristics of tasks, a multi-core processor-based scheduler exhibits excellent performance if tasks are fairly assigned to a plurality of cores by a load balancer. Accordingly, multi-core processor-based schedulers generally include an algorithm for fairly assigning tasks to a plurality of cores. A monitoring means for evaluating performance needs to be designed to be suitable for a multi-core processor, a detailed configuration of which is illustrated in FIG. 2.

If a task is requested by an application, the load balancer 21 divides the task into a plurality of smaller unit tasks so that the smaller unit tasks can be performed in parallel by the respective cores. In this case, the size of the unit tasks may be determined by considering the number and performance of cores, the configuration of the entire computing system, and the characteristics of tasks that should be performed in an integrated manner. Once the division into the unit tasks has been performed, initial tasks are assigned to the respective cores. The quantity of the initial tasks may be determined by considering the number and performance of cores, the configuration of the entire computing system, and the characteristics of tasks that should be performed.

The respective cores perform the assigned tasks. In this case, the load balancer 21 may assign tasks to the respective cores in such a manner that the schedulers 22a, 22b, 22c and 22d provided for the respective cores input a plurality of pieces of information about the unit tasks to the respective execution queues 23a, 23b, 23c and 23d. Likewise, the multi-core processor 10 according to this embodiment of the present invention includes the internal schedulers 22a, 22b, 22c and 22d, and the execution queues 23a, 23b, 23c and 23d for respective cores, unlike a single core processor.

Each of the respective cores is any one of a central processing unit (CPU), a digital processing processor (DSP) and a graphic processing unit (GPU). The cores may be identical cores or different cores.

FIG. 2 is a diagram illustrating the configuration of an apparatus 100 for monitoring the performance of cores based on a multi-core processor according to an embodiment of the present invention.

Referring to FIG. 2, an apparatus 100 for monitoring performance according to this embodiment of the present invention includes a status information collection unit 110, a monitoring unit 120, and a storage unit 130.

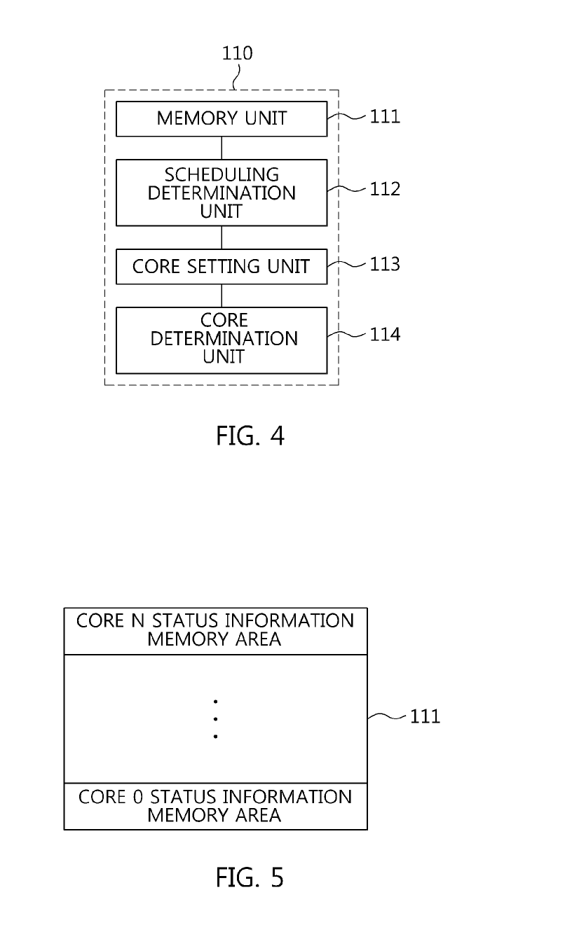

The status information collection unit 110 collects respective pieces of status information extracted from a plurality of cores, and stores the status information in corresponding memory areas provided therein. The status information may be information including at least one of the numbers of tasks or the amounts of data that have been processed for the respective cores. The detailed configuration of the status information collection unit 110 is described in the detail with reference to FIG. 4.

The monitoring unit 120 receives the status information collected by the status information collection unit 110, sends the status information to the storage unit 130, and performs monitoring to measure the performance of cores based on the status information. As an example of a method of performing monitoring to measure the performance of a plurality of cores, there is a method of obtaining the arithmetic mean of the processing speeds of tasks by dividing the number of unit tasks, which have been performed by respective cores, or the amount of data, which have been processed during the performance of the unit tasks, by the performance time of the unit tasks. The cores may always have identical performance when tasks are performed. Meanwhile, in some devices, the performance of cores may be increasingly improved because of the influence of transmission time or the caching of code. If necessary, it may be possible to use only recent unit tasks, other than all tasks performed, in order to measure the performance of cores. Based on this information, it is possible to monitor the performance of the cores while periodically updating the status information, that is, the number of unit tasks or the amount of data that have been processed by the cores during a unit time period.

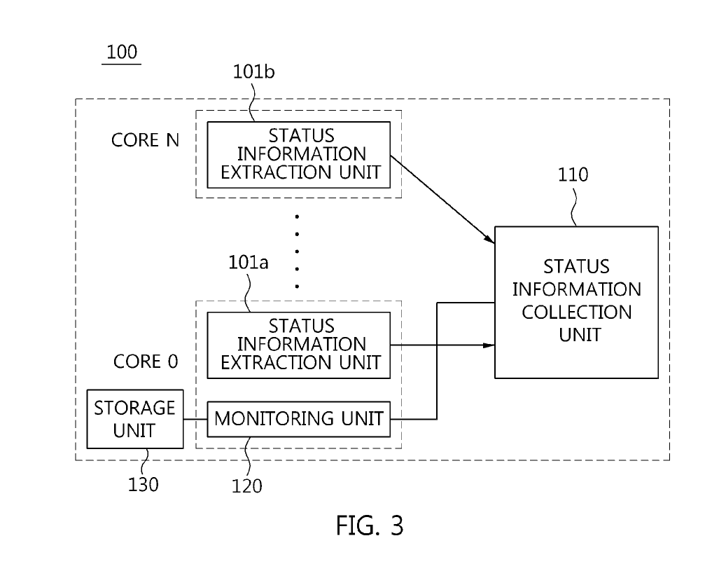

FIG. 3 is a diagram illustrating the detailed configuration of an apparatus for monitoring the performance of cores based on a multi-core processor according to an embodiment the present invention, FIG. 4 is the diagram illustrating the detailed configuration of a status information collection unit adopted in an apparatus for monitoring the performance of cores based on a multi-core processor according to an embodiment of the present invention, and FIG. 5 is a diagram illustrating the detailed configuration of a memory unit provided in the status information collection unit of FIG. 4.

Referring to FIG. 3, the apparatus for monitoring the performance of cores based on a multi-core processor according to the embodiment of the present invention includes a plurality of cores, status information extraction units 101a and 101b provided in the respective cores, a status information collection unit 110, a monitoring unit 120 provided in any one of the cores, and a storage unit 130.

The status information extraction units 101a and 101b are provided in the respective cores, and extract only the status information of the cores to which the status information extraction units 101a and 101b belong. As described above, the status information may be information including at least one of the numbers of tasks or the amounts of data that have been processed for the respective cores. The reason why the status information extraction units 101a and 101b are provided for the respective cores as described above is that the load consumed to monitor the performance of the cores is fairly distributed, thereby making the evaluation of the performance of cores fair.

The status information extraction units 101a, 101b send the extracted status information to the status information collection unit 110. The extraction and sending of the status information of the status information extraction units 101a and 101b may vary depending on the requirements of the monitoring unit 120 for measuring performance. For example, if the monitoring unit 120 desires to monitor the performance of the cores in specific periods, the status information extraction units 101a and 101b may extract the status information of the respective cores in accordance with the specific periods and then send the status information to the status information collection unit 110. If the monitoring unit 120 desires to monitor the performance of the cores after the completion of the tasks of the cores, the status information extraction units 101a and 101b may extract the status information of the cores in accordance with the completion of the tasks and then send the status information to the status information collection unit 110.

The status information collection unit 110 collects a plurality of pieces of status information extracted from the respective cores, and stores the plurality of pieces of status information in respective memory areas provided therein.

For this purpose, the status information collection unit 110 includes a memory unit 111, a scheduling determination unit 112, a core setting unit 113, and a core determination unit 114, as illustrated in FIG. 4.

The memory unit 111 has a plurality of different memory areas for the respective cores, and stores the collected pieces of status information in the corresponding memory areas. That is, the memory unit 111 periodically assigns different memory areas for the respective cores, and collects the plurality of pieces of status information of the respective cores, and stores the plurality of pieces of status information in the corresponding memory areas. As illustrated in FIG. 5, the status information collection unit 110 stores the status information extracted from a core 0 in a core 0 status information memory area, and stores the status information extracted from a core N in a core N status information memory area.

The scheduling determination unit 112 determines whether each of tasks assigned to the respective cores corresponding to the plurality of respective pieces of status information that are stored in the memory areas is a scheduling target.

The core setting unit 113 fixedly sets the positions of tasks so that the tasks can be performed only in assigned cores. Therefore, even when each of the tasks is scheduled later, it may be performed again in the assigned core.

The core determination unit 114 determines whether a task, which is a scheduling target, has been assigned to a core provided with the monitoring unit 120. If the task, which is a scheduling target, has been assigned to the core provided with the monitoring unit 120, the monitoring unit 120 monitors the performance of core.

The monitoring unit 120 is provided in any one of the respective cores, sends the plurality of pieces of status information, collected by the status information collection unit 110, to the storage unit 130, and performs monitoring based on the status information.

That is, the monitoring unit 120, if it is determined by the core determination unit that a task that is a scheduling target is a task assigned to the core provided with the monitoring unit 120, sends the stored status information to the storage unit 130, resets the status information collection unit 110, and then performs the monitoring.

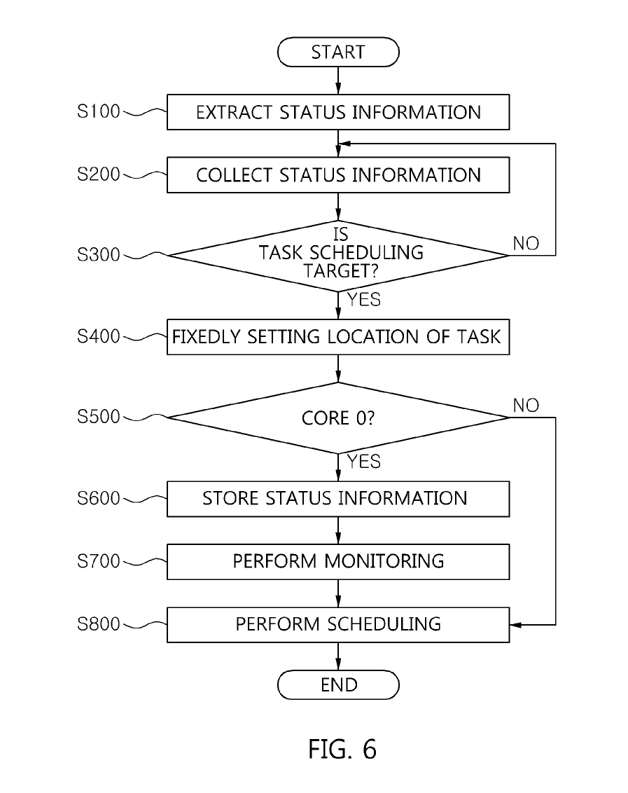

FIG. 6 is a diagram illustrating the sequence of a method of monitoring the performance of cores based on a multi-core processor according to an embodiment of the present invention.

Referring to FIG. 6, since the method of monitoring the performance of cores based on the multi-core processor according to this embodiment of the present invention is a method using the above-described apparatus for monitoring the performance of cores based on the multi-core processor, redundant descriptions are omitted.

First, when a kernel starts, the status information extraction units 101a and 101b are assigned to respective cores at step S100. The monitoring unit 120 is assigned to any one of the cores.

Thereafter, each of the assigned status information extraction units 101a and 101b sends status information, extracted from the core to which the status information extraction units 101a or 101b has been assigned, to status information collection unit 110 at step S200. In this case, the status information collection unit 110 assigns different memory areas for the respective cores, periodically collects a plurality of pieces of status information from the respective cores, and stores the plurality of pieces of collected status information in the respective memory areas.

Thereafter, it is determined whether each of tasks assigned to the respective cores corresponding to the plurality of pieces of status information that are stored in the memory areas is a scheduling target at step S300. In this case, if the assigned task is a scheduling target, CPU affinity for fixedly setting the location of the task so that the task is performed only in the assigned core is set at step S400. In contrast, if the assigned task is not a scheduling target, the process returns to step S200.

Thereafter, it is determined whether the task that is determined to be a scheduling target at step S300 is a task that has been assigned to the core provided with the monitoring unit 120 at step S500.

If the task that is determined to be a scheduling target at step S300 is a task that has been assigned to the core provided with the monitoring unit 120, the plurality of pieces of status information of all the cores stored in the status information collection unit 110 are sent to the storage unit 130 at step S600.

Thereafter, the status information collection unit 110 is reset, and the performance of the cores is monitored at step S700.

Finally, the scheduling of the corresponding task is performed at step S800. If the task scheduled at step S500 is not a task that has been assigned to the core provided with the monitoring unit 120, the process returns to step S800.

As described above, the apparatus and method for monitoring the performance of cores according to the present invention has the advantage of equally assigning the loads of monitoring to respective cores because in order to evaluate the performance of the cores attributable to an operating system based on a multi-core processor, they can collect a plurality of pieces of status information for the respective cores and then monitor the performance of the cores.

Furthermore, the apparatus and method for monitoring the performance of cores according to the present invention have the advantage of fairly monitoring the performance of all schedulers because a monitoring means is provided in any one of the cores.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for monitoring performance of cores based on a multi-core processor, comprising:
a status information collection unit configured to collect a plurality of pieces of status information extracted from respective cores, and to store the plurality of pieces of status information in respective memory areas provided for the cores; and
a monitoring unit configured to receive the status information, to send the status information to a storage unit, and to perform monitoring based on the status information,
wherein the monitoring unit is provided in any one of the cores.

2. The apparatus of claim 1, wherein the cores comprise respective status information extraction units each configured to extract the plurality of pieces of status information.

3. The apparatus of claim 1, wherein each of the plurality of pieces of status information is information including at least one of a number of tasks or an amount of data that have been processed for each of the cores.

4. The apparatus of claim 1, wherein the status information collection unit comprises:
a memory unit configured to have a plurality of different memory areas for the respective cores, and to store the plurality of pieces of collected status information in the respective memory areas;
a scheduling determination unit configured to determine whether each of tasks, which have been assigned to the respective cores corresponding to the plurality of pieces of status information that are stored in the respective memory areas, is a scheduling target;
a core setting unit configured to fixedly set locations of the tasks so that the tasks are performed only in the respective assigned cores; and
a core determination unit configured to determine whether the task, which is a scheduling target, has been assigned to the core provided with the monitoring unit.

5. The apparatus of claim 1, wherein the monitoring unit, if the task, which is a scheduling target, is a task assigned to the core provided with the monitoring unit, sends the stored status information to the storage unit, resets the status information collection unit, and then performs the monitoring.

6. A method of monitoring performance of cores based on a multi-core processor, comprising:
collecting, by a status information collection unit, a plurality of pieces of status information extracted from respective cores, and storing, by the status information collection unit, the plurality of pieces of status information in respective memory areas provided for the respective cores; and
storing, by a monitoring unit provided in any one of the respective cores, the plurality of pieces of collected status information in a storage unit, and performing, by the monitoring unit, monitoring based on the status information.

7. The method of claim 6, further comprising, before collecting the plurality of pieces of status information extracted from the respective cores and storing the plurality of pieces of information in the respective memory areas, providing the cores with respective status information extraction units each configured to extract the plurality of pieces of status information.

8. The method of claim 6, wherein collecting the plurality of pieces of status information extracted from the respective cores and storing the plurality of pieces of information in the respective memory areas comprises:
storing the plurality of pieces of collected status information in respective different memory areas provided for the respective cores;
determining whether each of tasks, which are assigned to the respective cores corresponding to the plurality of pieces of status information stored in the memory areas is, a scheduling target;
fixedly setting positions of the tasks so that the tasks are performed only in the respective assigned cores; and
determining whether the task, which is a scheduling target, has been assigned to the core provided with the monitoring unit.

9. The method of claim 6, wherein storing the plurality of pieces of collected status information in the storage unit and performing monitoring based on the status information comprises:
determining whether the core to which the task, which is a scheduling target, has been assigned is the core provided with the monitoring unit; and
storing the plurality of pieces of collected status information in the storage unit, resetting the status information collection unit, and then performing the monitoring.
